(19) United States
(12) Patent Application Publication
(10) Pub. No.: US 2003/0160890 A1
(43) Pub. Date: Aug. 28, 2003

(54) Presenting electronic images

(75) Inventors: Robert Caspe, Sherbourne, MA (US); Michael Harris, Concord, MA (US); Eugene Zarkin, Boston, MA (US)

Correspondence Address: HALE AND DORR, LLP, 60 STATE STREET, BOSTON, MA, 02109

(73) Assignee: Sound Vision, Inc., Wayland, MA (US)

(21) Appl. No.: 10/083,719

(22) Filed: Feb. 26, 2002

(51) Int. Cl. H04N 5/225

(52) U.S. Cl. 348/372

(57) ABSTRACT

A system having a battery powered camera and a docking station is used in presenting electronic images. The camera includes an electronic image sensor generating an electronic image, a television signal generator deriving a television signal from the electronic image, and a docking station connector receiving the television signal and exposing the television signal. The docking station includes a platform for receiving the battery powered camera in a docked position, a camera connector for receiving the television signal from the docking station connector of the battery powered camera, and a television connector for supplying the television signal to television equipment.

### BACKGROUND OF THE INVENTION

This invention relates to presenting electronic images.

Electronic apparatus that uses a charge coupled device or other sensor to derive an electronic signal from an optical image picked up by a lens, and that stores the signal on a recording medium, such as a semiconductor memory, a tape, or a floppy-disk, is known as an electronic camera. By storing the image in the form of electrical information, the electronic camera enables other devices to perform various image processes on the image, such as presenting the stored image on a television receiver or transmitting the stored image to a remote area via a transmission channel. The other devices accept the stored electrical information, or a reproduction thereof, and execute computer instructions to perform the image processes.

Recording images electronically can be less expensive than using traditional film cameras, which rely on costly film and print. However, a high initial cost is associated with electronic cameras that have removable media, such as the Sony Mavica which has a built in floppy disk drive. At least one electronic camera has been produced that lacks a floppy drive and that can generate a video signal to cause stored images to be displayed on a television screen. Some electronic cameras can transmit stored images via computer cables to personal computers for display on computer screens. Docking stations are available that serve as intermediaries between electronic cameras (such as the Kodak EasyShare and the Ricoh Caplio) and personal computers. Set top box products such as photela TV Slideshow and iomega FotoShow have been produced that accept removable electronic storage media (such as magnetic disk media) and cause a television to display images stored on the storage media.

### SUMMARY OF THE INVENTION

A system having a battery powered camera and a docking station is used in presenting electronic images. The camera includes an electronic image sensor generating an electronic image, a television signal generator deriving a television signal from the electronic image, and a docking station connector receiving the television signal and exposing the television signal. The docking station includes a platform for receiving the battery powered camera in a docked position, a camera connector for receiving the television signal from the docking station connector of the battery powered camera, and a television connector for supplying the television signal to television equipment.

Implementations of the invention may provide one or more of the following advantages. A user can view electronic images such as digital pictures on a standard television, e.g., in a hotel room, regardless of whether a personal computer is available. If a floppy disk drive is provided, electronic images can be saved on floppy disks without the aid of a personal computer. The floppy disks can then be shared and used to print out the images. Electronic images can be saved on videotape, e.g., in slide show format.

Other advantages and features will become apparent from the following description, including the drawings, and from the claims.

### BRIEF DESCRIPTION OF THE DRAWINGS

FIG. 1 is a block diagram of an electronic photography system.

FIGS. 2-3 are illustrations of an electronic photography system.

FIGS. 4-16 are circuit diagrams of aspects of an electronic photography system.

### DETAILED DESCRIPTION

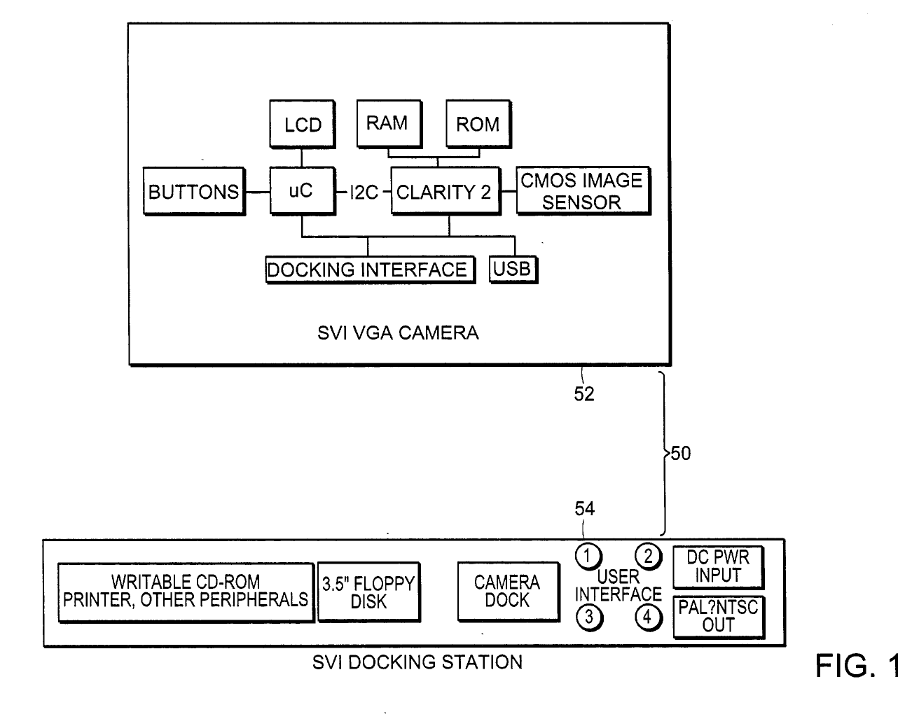

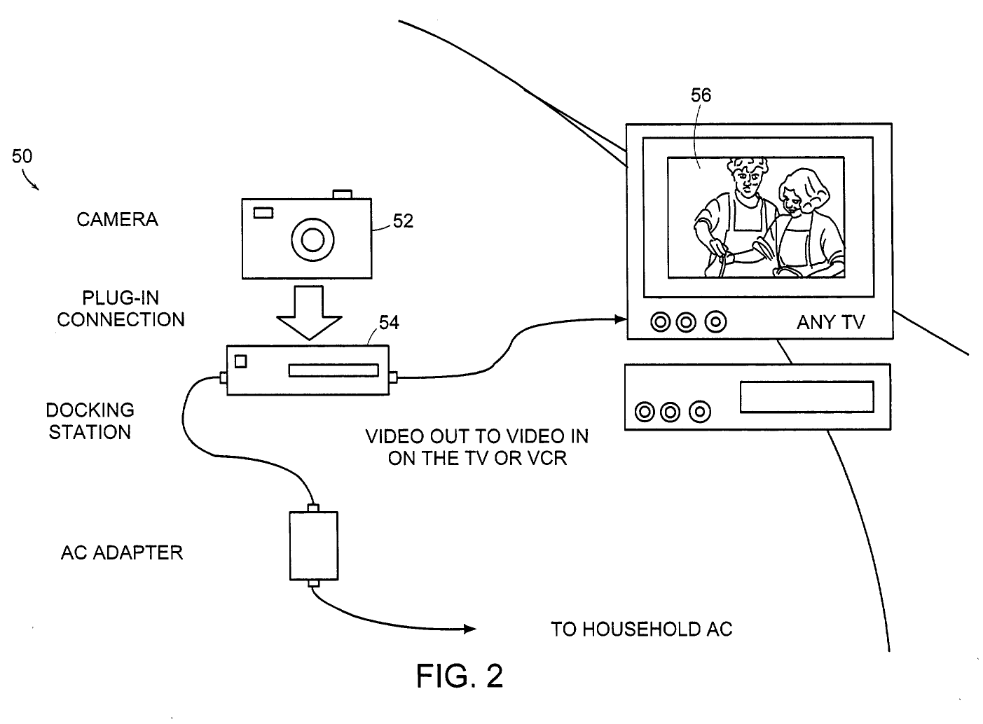

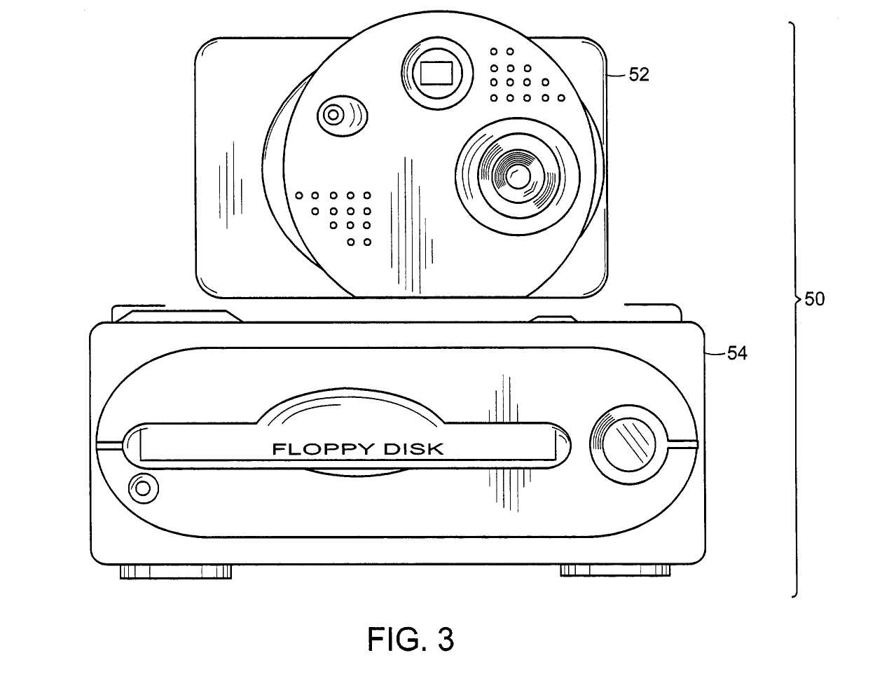

As shown in block diagram and pictorial form in FIGS. 1-3 and as described in more detail below, an electronic photography system 50 having an electronic camera 52 and a docking station 54 allows electronic images stored by the digital camera to be displayed on a conventional television screen 56. As a result, the electronic images can be displayed on a screen without the aid of a personal computer. In addition, as described below, the camera and the docking station are configured so that the docking station provides powerful features yet can be produced simply and inexpensively.

Additional features provided by the electronic photography system include allowing the deletion of unwanted electronic images, allowing electronic images to be copied to removable storage media (such as a 3.5-inch floppy diskette), allowing the viewing on television of electronic images not produced by the system's own camera, and allowing the viewing on television, and recording on a videocassette recorder (VCR), of a slide show of electronic images produced by the camera.

In particular, the system uses a method by which the camera can be used to display and edit pictures without the need of a personal computer. In a specific implementation, the camera's electronics produce a video signal that is passed through the docking station to the television system. The video signal is a composite signal that is compatible with a conventional composite video input of a VCR or a television. If the VCR or television does not have an input jack for composite video, a radio frequency (RF) modulator device (available from electronic supply stores such as Radio Shack) can be used to derive, from the composite signal, a radio frequency signal that can be supplied to VCR's or television's antenna input (e.g., as television channel 3 or 4). In specific implementations, the video signal is compatible with National Television System Committee (NTSC) or Phase Alternating Line (PAL) television standards, and the camera may allow the video signal to be switched between NTSC compatibility and PAL compatibility.

Since the video signal is generated by the camera, it is unnecessary for the docking station to have a microprocessor for the purpose of generating the video signal. (In one or more embodiments, the docking station may use one or more microprocessors for another purpose, such as for controlling or communicating with a floppy disk drive, a compact disc (CD) drive, a printer, or a wireless device.) The docking station provides a physical base for the camera and may provide electrical power to the camera.

The system has a user interface implemented in the camera electronics with software that provides editing functionality using visual feedback from the television. Images can be displayed using the camera's electronics and image data from the camera's internal memory (e.g., flash or synchronous dynamic random access memory (SDRAM)), or from a floppy disk drive or a CD drive, or from other peripherals connected to the docking station. The system can overlay the text and graphics information not inherent in the images to provide feedback for the user interface. The images can be stored in, and edited and displayed from, the camera's memory (which, depending on the implementation, may include a removable flash memory card) or a floppy disk or a write-capable CD drive. The camera may use a data compression technique to store images efficiently in data storage.

The user interface may allow one or more of the following functions. Images may be edited by cropping, panning, color correction, altering compression parameters, and rotation. Images may be managed by insertion, deletion, naming, copying, and changing to a next or previous image. A slide show mode may be provided that allows images to be shown automatically in succession, e.g., every 5 seconds.

Input to the user interface can be provided via buttons on the camera, the docking station, or, depending on the implementation, a separate wireless remote control.

A Universal Serial Bus (USB) interface may be provided on the camera for an optional connection to a personal computer.

In a specific implementation, the camera includes a digital camera that has a complementary metal-oxide semiconductor (CMOS) Video Graphics Array (VGA) resolution sensor and a fixed focus lens with viewfinder. The sensor has a resolution of 640×480 with an integral 10 bit analog to digital converter (AID). The camera has a monochrome liquid crystal display (LCD) screen showing camera status, a USB connector for the USB interface described above, and a timer for unattended picture taking. The camera also has 8 megabytes (MB) of memory (e.g., SDRAM), which can store 40, 60, or 110 images in fine (JPEG 640×480, Independent JPEG Group quality factor 90), normal (JPEG 640×480, Independent JPEG Group quality factor 70), or economy resolution (JPEG 320×240, Independent JPEG Group quality factor 70), respectively. (If the camera has less memory, such as 2 MB, commensurately fewer images may be stored.) A rapid fire mode of picture taking is provided that allows the camera to take multiple pictures automatically in unattended fashion.

In a specific implementation, the docking station has a 3.5-inch floppy disk drive, four control buttons (labeled “menu”, “select”, “next”, and “previous”) for use with graphical user interface icons on the television screen, a docking connector for communicating with the camera when the camera is seated at the docking station, an alternating current (AC) or direct current (DC) adapter connector (or AC and DC adapter connectors) for receiving electrical power, and a video signal output cord having a male RCA connector. The docking station may have circuitry that allows the use of 110 or 220 volts of alternating current (VAC) electrical power.

With respect to the features made available to the user, the floppy drive of the docking station is front-loaded and has a status light emitting diode (LED). The “menu” control button of the docking station causes an on-screen menu to be shown or hidden. Icons shown on the screen allow selection of features including selection of images from the camera's memory or from a floppy diskette, viewing the next image or the previous image, copying an image, copying all images, deleting the current image (with confirmation), deleting all images (with confirmation), rotating the current image 90 degrees left or right, the slide show, and floppy disk status (memory remaining, whether the diskette is full, whether an image copying procedure is in progress, and whether an error has occurred). A single 3.5-inch floppy diskette may hold approximately 24 images (of resolution JPEG 640×480, Independent JPEG Group quality factor 70).

The USB connector provides a connection to a personal computer and allows images to be transferred to the personal computer and manipulated at the personal computer.

The floppy disk drive allows copies of images to be given to others, and allows images to be taken to a photo kiosk for printing. The video signal output allows images to be recorded by a VCR, so that, for example, a slide show of images can be recorded on a videocassette.

In a specific implementation, the camera uses a CLARITY programmable application specific integrated circuit (ASIC) device, available from Sound Vision, Inc., 432 Boston Post Road (Route 20), Wayland, Mass. 01778. The CLARITY ASIC combines hardware, software, and services to provide flexibility. In particular, the ASIC is a Clarity 2, ARM7 48 megahertz (MHz) ASIC with an integral cache.

The camera may have a beeper to output audible information such as status beeps or alarms, and may have a strobe flash for high speed or low light conditions. When the camera is not seated at the docking station, the camera may be powered by batteries, such as four AA or AAA size batteries, and may have an automatic power off function that causes the camera to turn off after a period of inactivity.

A movie mode feature may be provided by the camera that causes the camera to take images at a rate of 10 frames per second (fps) at a resolution of 160×120, and with an available digital 2×zoom, automatic white balance, and automatic exposure.

The camera may be able to deliver PC video via the USB port, in a resolution such as 160×120, 320×240, or 640×480. The personal computer may run an operating such as Windows 98/2000/ME or Mac OS 9, and may have a Windows 98/2000/ME compatible TWAIN driver and a Windows 98/2000/ME video driver.

Electrical power may be provided to the docking station (and to the camera through the docking connector) by an AC/DC converter having an external power supply that converts standard AC power to a DC level to meet the systems's operating needs. When the AC/DC converter is connected to the docking station and the camera is properly docked, the camera is powered by the external power supply and not by the camera's batteries. An LED on the camera lights up to indicate that power is on.

The camera may have 500 kilobytes of read only memory (ROM) for program code storage, and may store images in an Exchangeable Image File Format (EXIF) compliant Joint Photographic Experts Group (JPEG) format. The SDRAM that stores the images is volatile memory, i.e., the SDRAM retains its contents only when supplied with electrical power, even when the camera is set to an Off mode. Thus, in the case of SDRAM memory, the images are lost if the camera's batteries are totally depleted. If the camera is turned off immediately when the low battery indicator appears on the status LCD, the residual power in the batteries is sufficient to maintain the SDRAM for several days. For more protection, a user should download the images out of the camera onto floppy disks or onto a personal computer, if available, as soon as possible when the low battery indication appears. For the same reasons, a user should store images out of the camera prior to changing batteries.

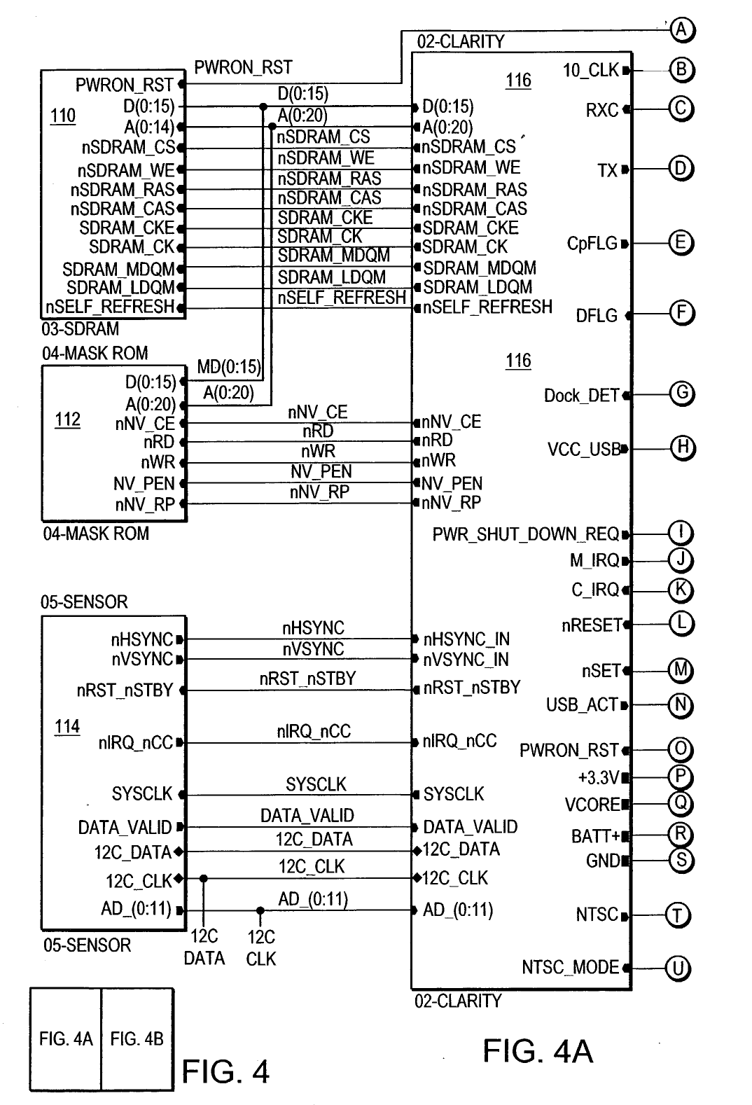

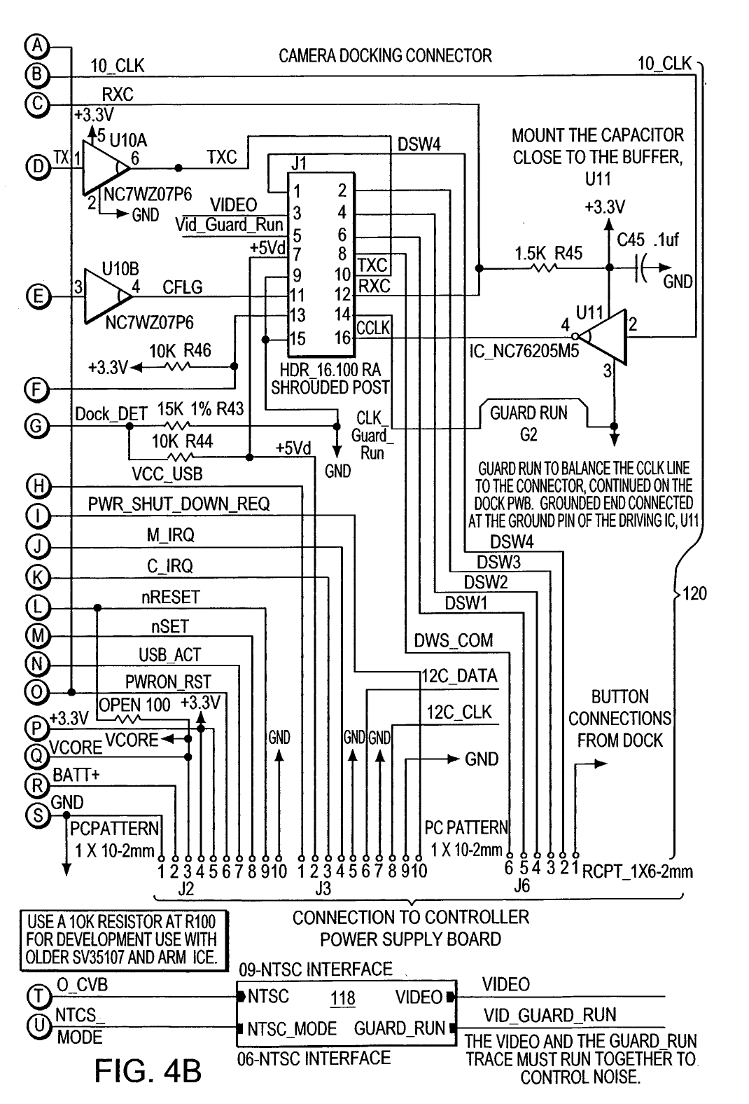

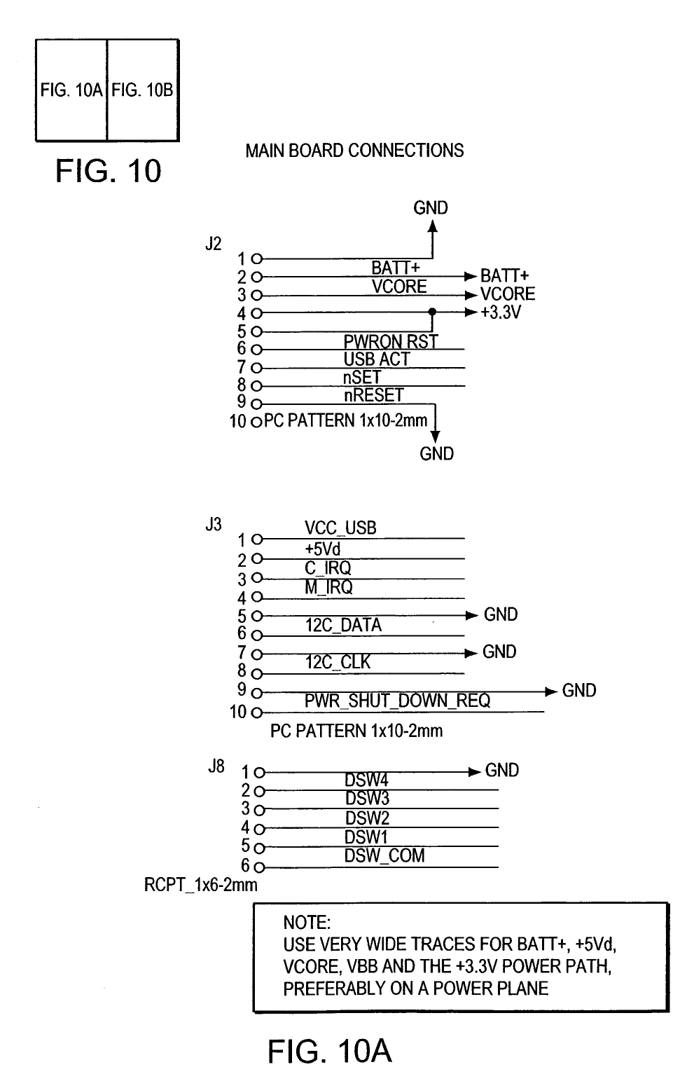

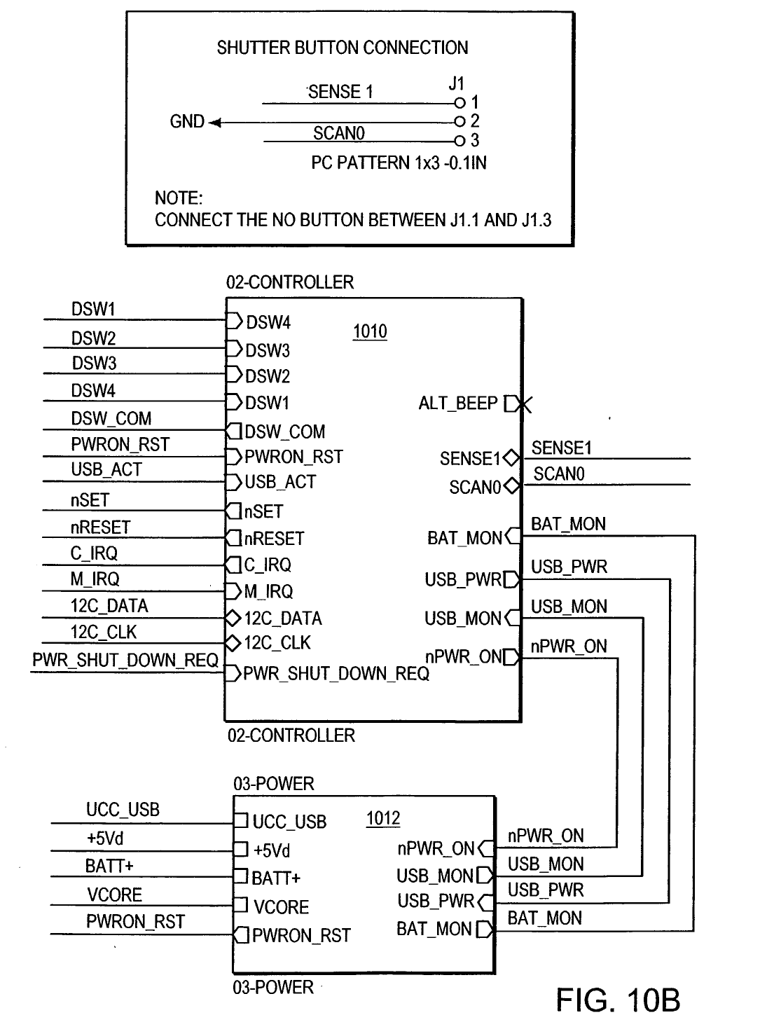

FIGS. 4-12 illustrate schematics of an example implementation of the camera. FIG. 4 illustrates a high level view of a main circuit board of the camera, and FIG. 10 illustrates a high level view of a controller/power circuit board of the camera. As shown in FIG. 4, the camera has processor circuitry 116 communicating with SDRAM circuitry 110, mask ROM circuitry 112, sensor circuitry 114, and NTSC interface circuitry 118, connector circuitry 120. The SDRAM circuitry includes semiconductor memory that stores electronic image data, the mask ROM circuitry stores computer program instructions executed by the processor circuitry, the sensor circuitry generates image data from the lens, the NTSC circuitry produces a composite video signal, and the connector circuitry communicates with the docking station and the controller/power circuit board. The processor circuitry executes according to the computer program instructions to retrieve image data from the sensor circuitry and store the image data in the SDRAM circuitry, and to supply the composite video signal to, and otherwise communicate with, the docking station and controller/power circuit board.

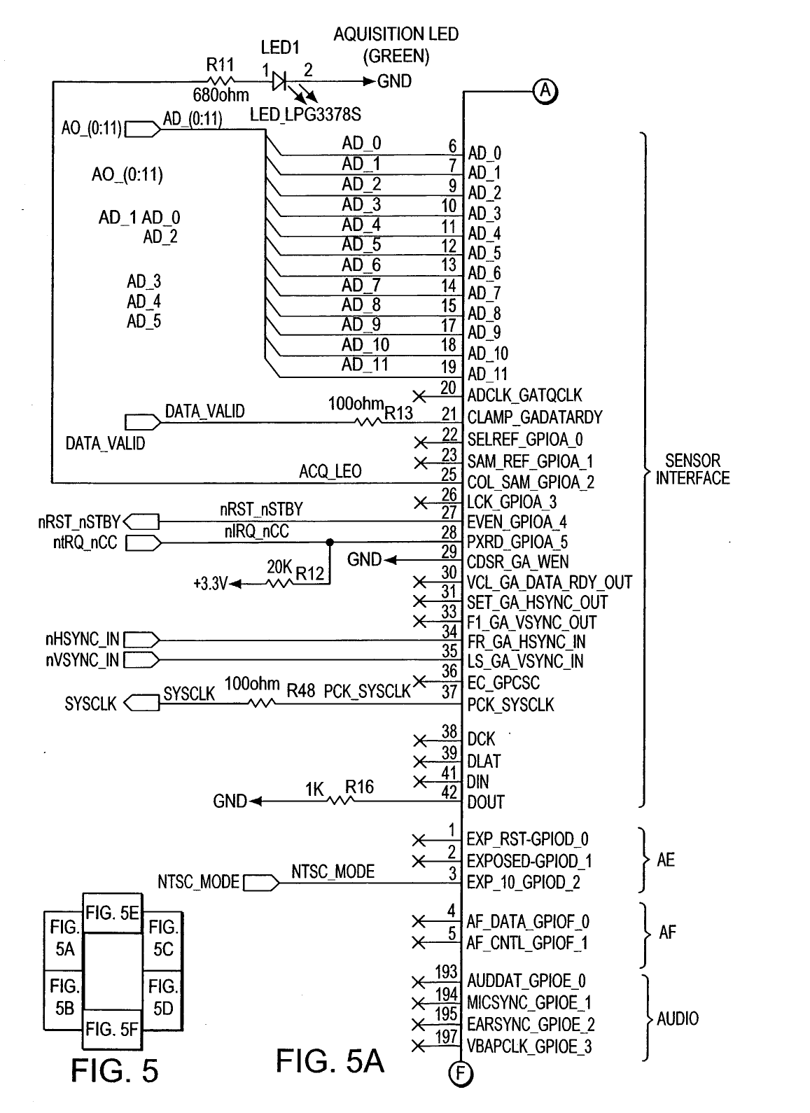

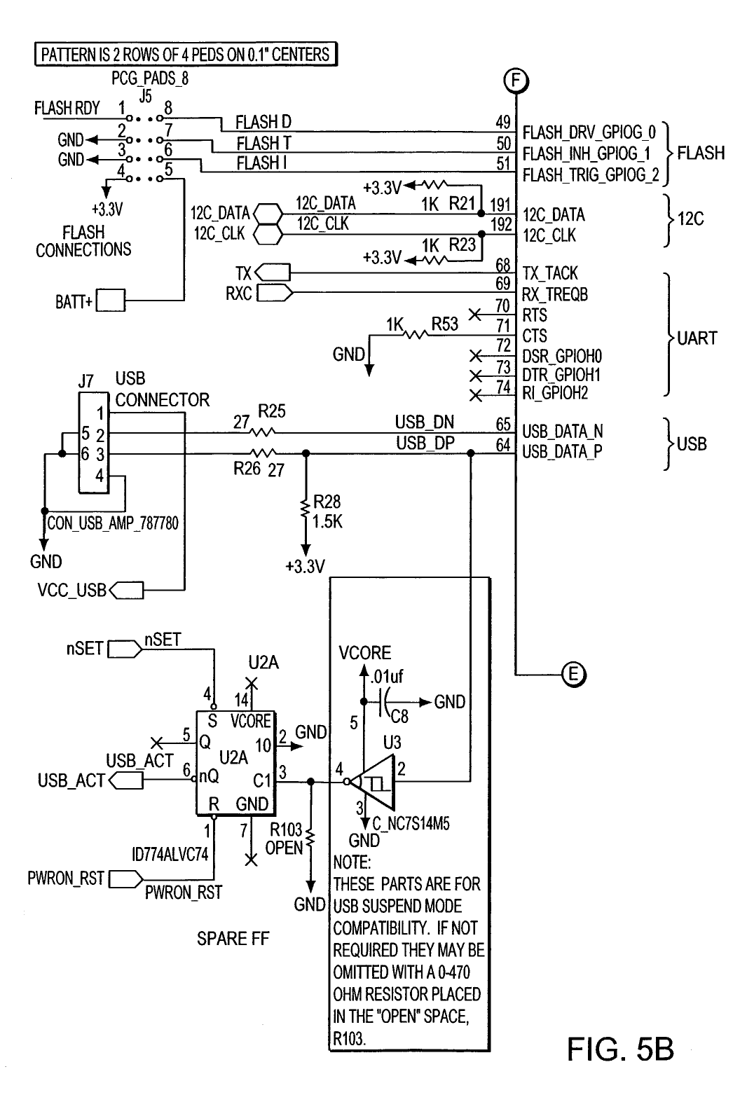

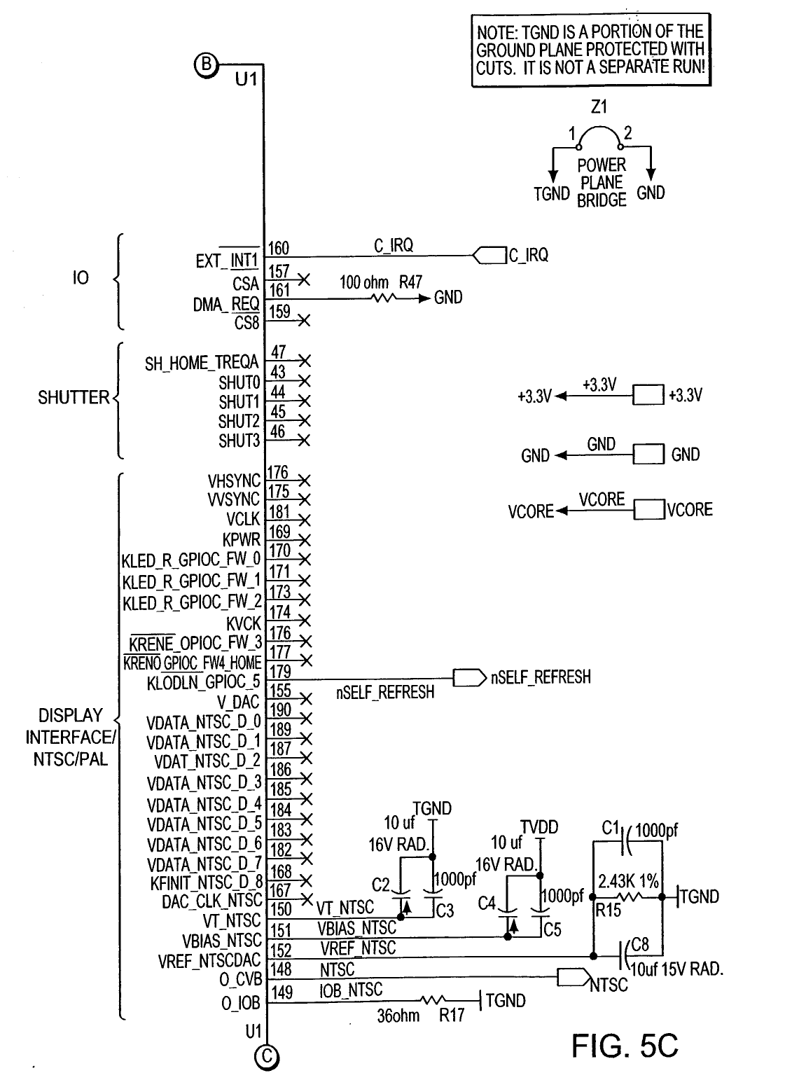

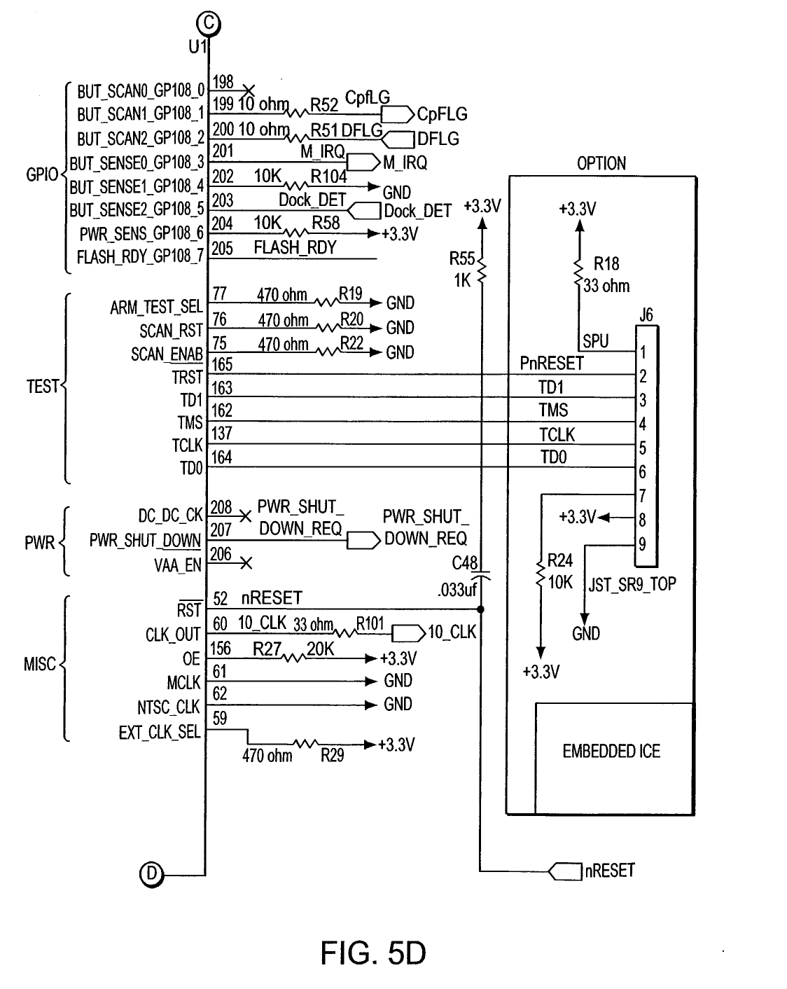

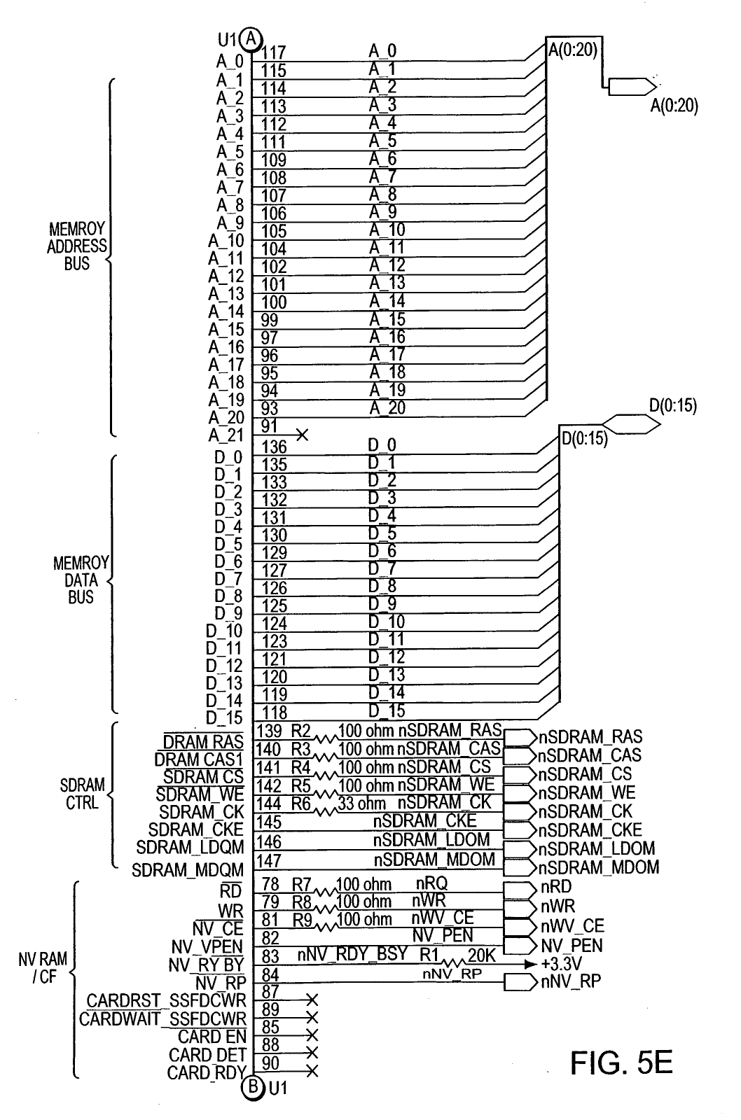

FIG. 5 illustrates the processor circuitry in detail. As shown, the processor circuitry is based on the Sound Vision Inc. Clarity 2 device that has many capabilities, including the ability to generate a composite video signal from electronic image data. Further information concerning the Clarity 2 device is available on the World Wide Web at http://www.soundvisioninc.corn/, and from Sound Vision, Inc., 432 Boston Post Road (Route 20), Wayland, Mass. 01778.

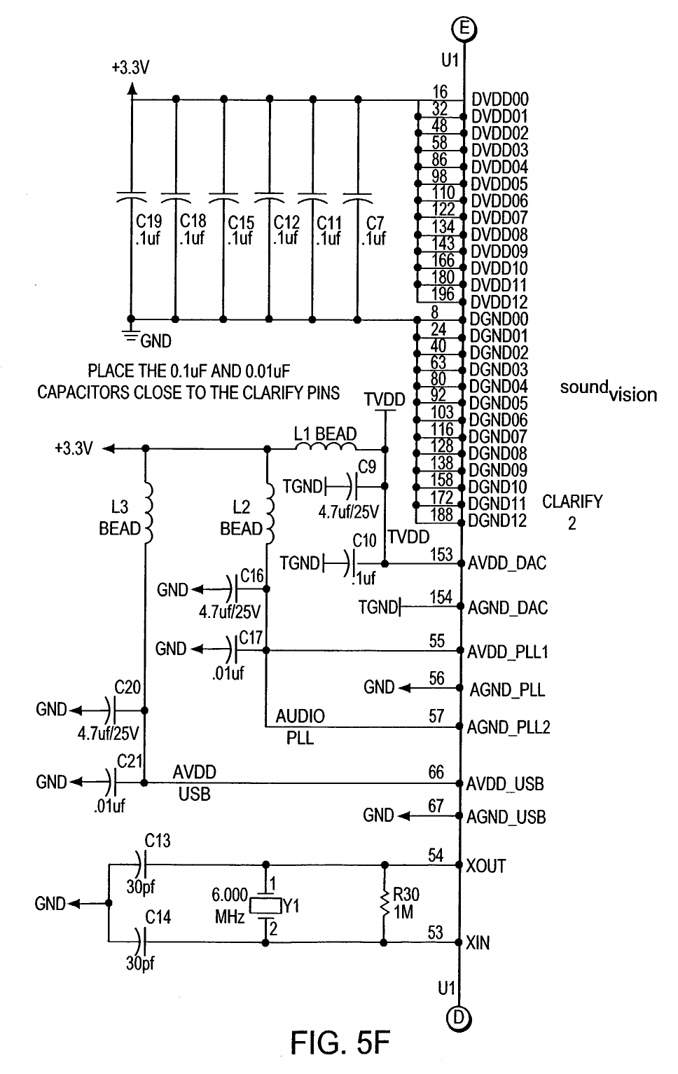

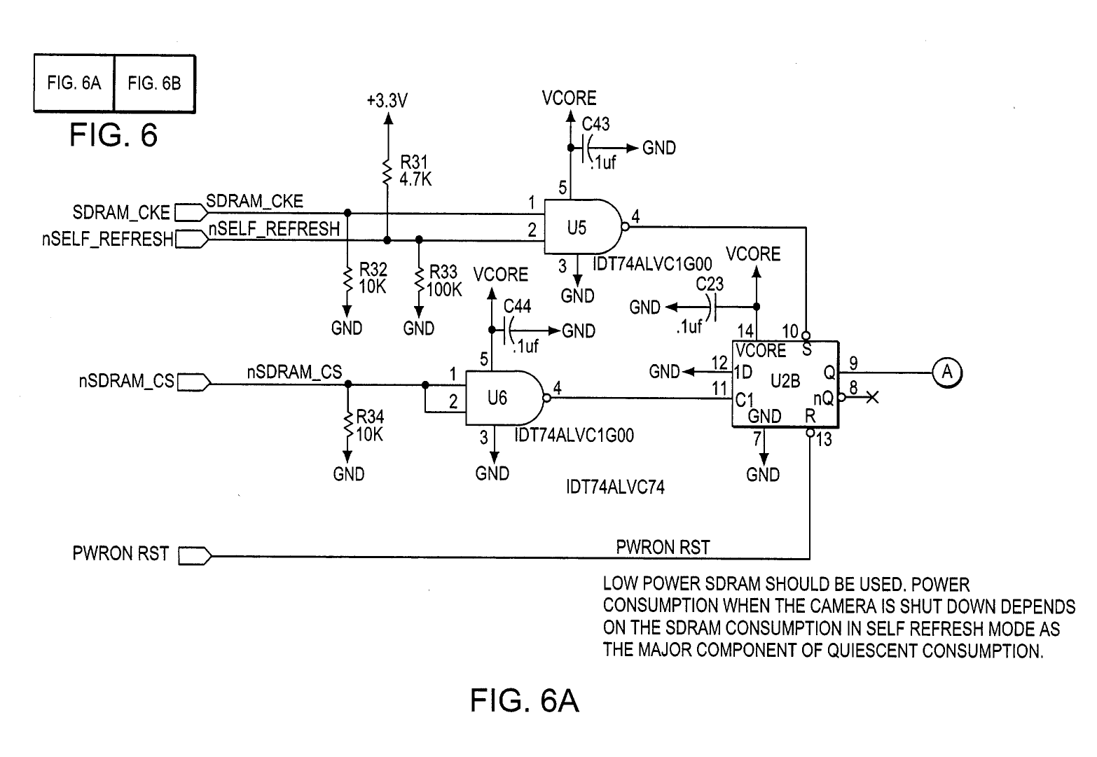

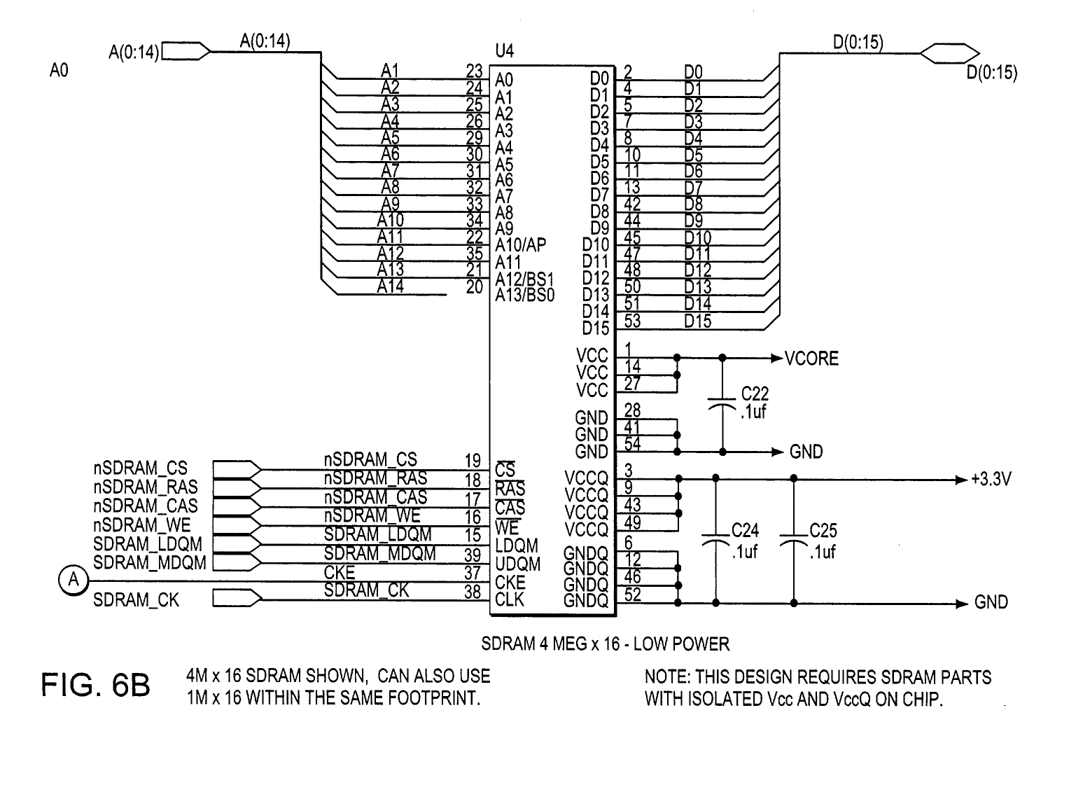

FIG. 6 illustrates the SDRAM circuitry in detail. In this specific implementation, the SDRAM circuitry includes a 4Meg×16 SDRAM device. Other implementations could use other memory devices, such as a 1Meg×16 SDRAM device.

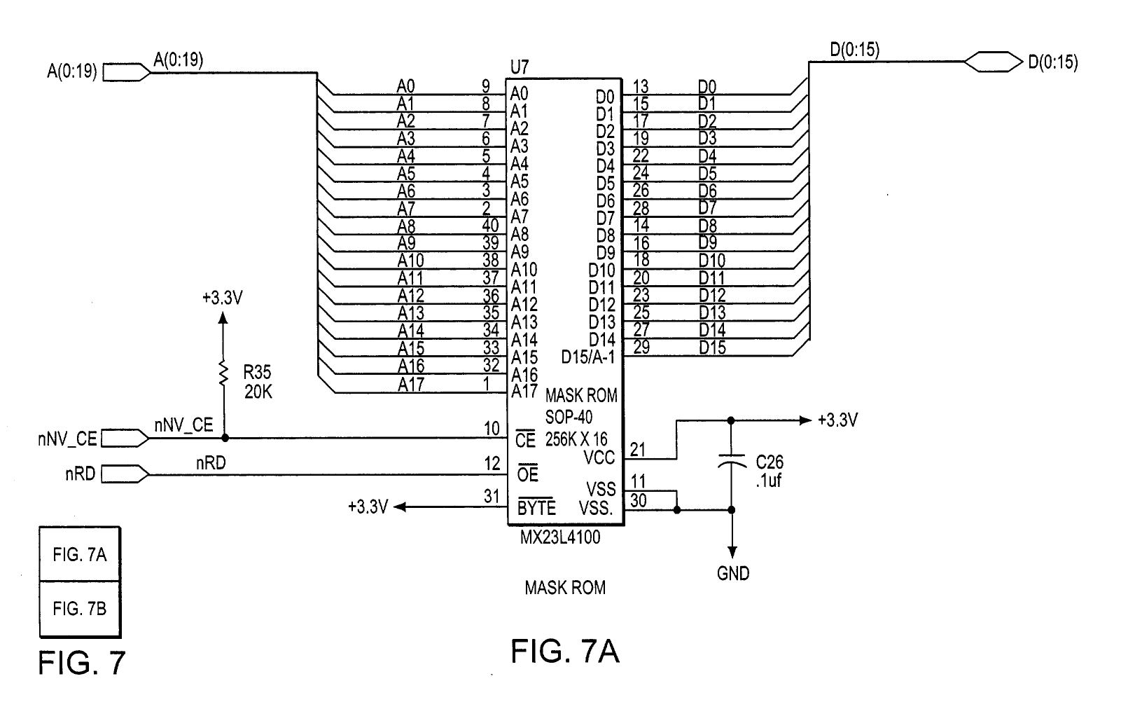

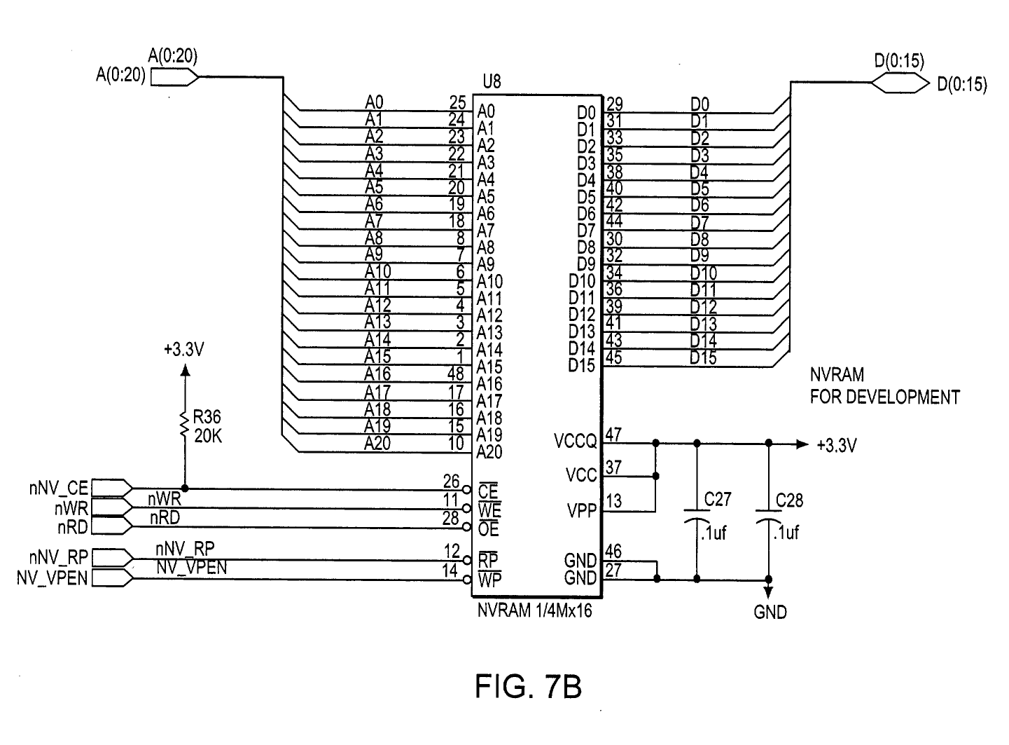

FIG. 7 illustrates the mask ROM circuitry in detail. In this specific implementation, a 256 k ×16 ROM device in an SOP-40 package is used. Nonvolatile random access memory (NVRAM) may be used in the mask ROM circuitry, e.g., for testing purposes during development.

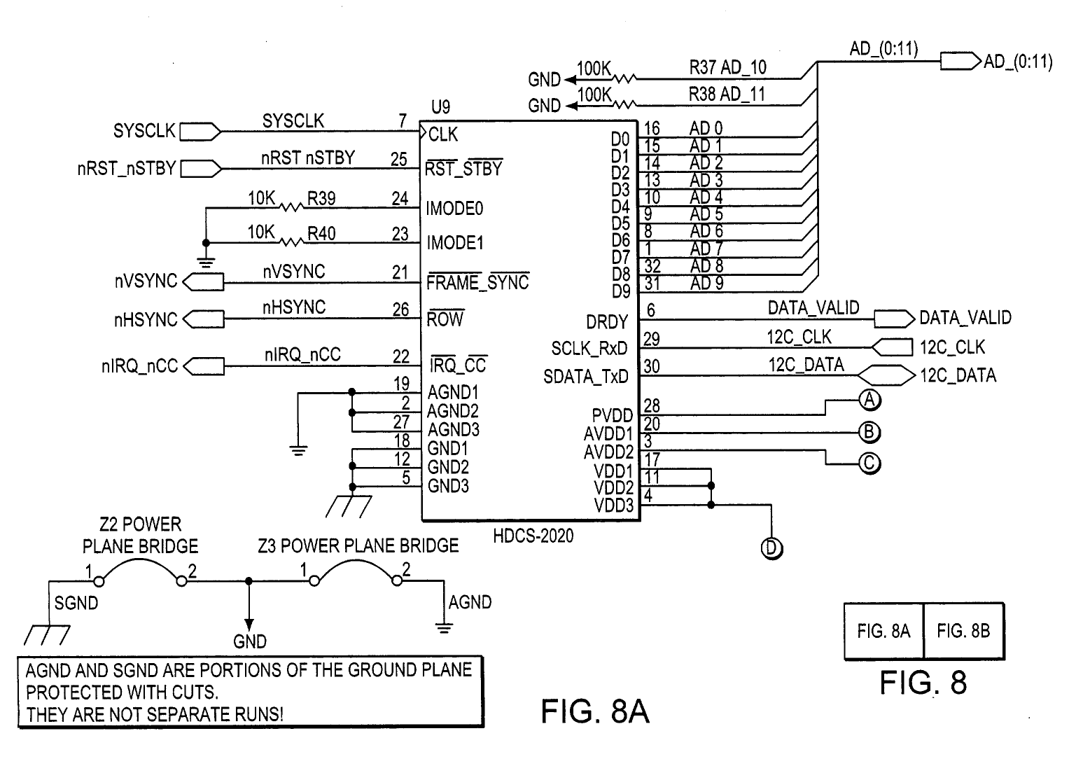

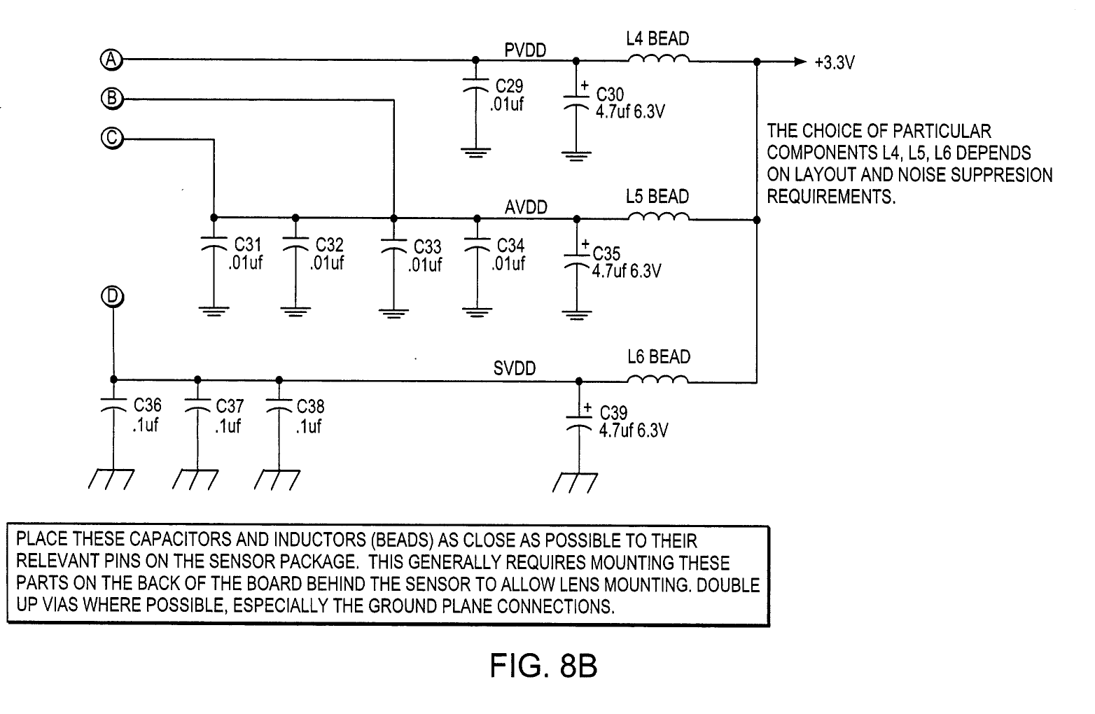

FIG. 8 illustrates the sensor circuitry in detail. In this specific implementation, an Agilent Technologies HDCS-2020 device is used.

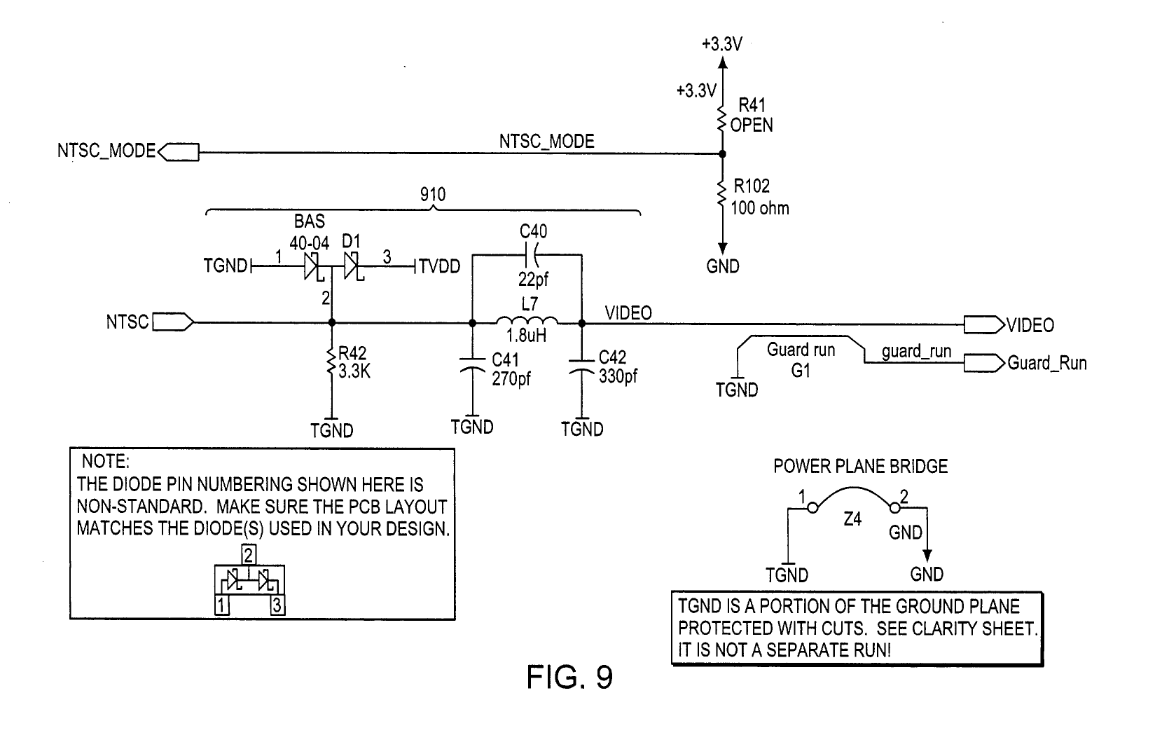

FIG. 9 illustrates the NTSC circuitry in detail. The NTSC mode is selected by the insertion or omission of resistors R41, R102. A passive filter 910 is used to derive the VIDEO signal from a raw NTSC signal from the processor circuitry.

As noted above, FIG. 10 illustrates a high level view of a controller/power circuit board of the camera. The controller/power circuit board, which has controller circuitry 1010 and power circuitry 1012, communicates with the main board via connectors J2, J3, J8. USB signals USB_MON and USB_PWR and power related signals nPWR_ON and BAT_MON are communicated between the controller circuitry and the power circuitry.

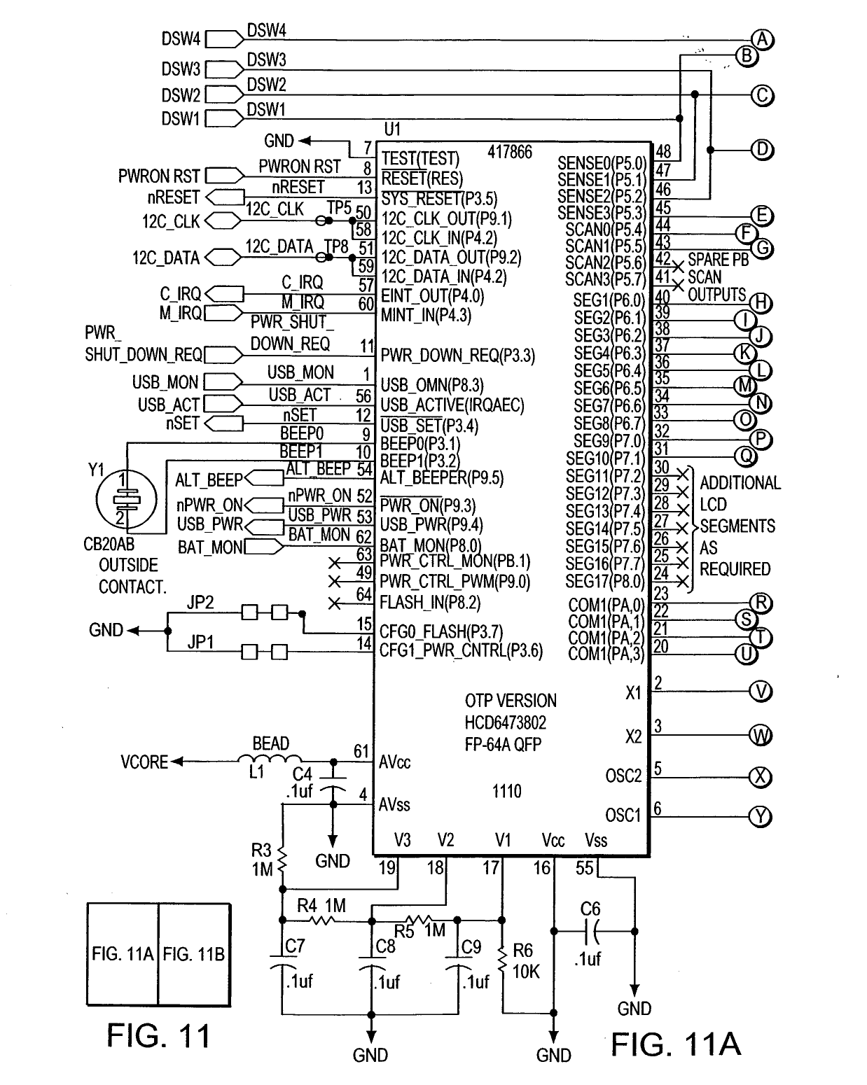

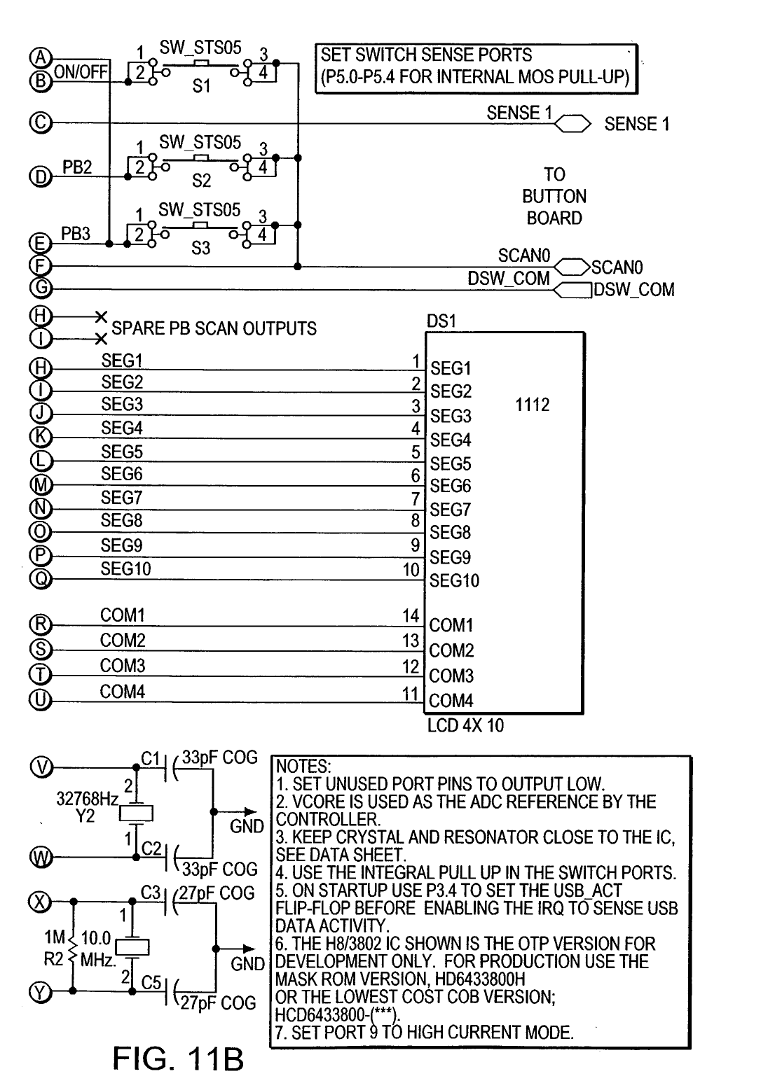

FIG. 11 illustrates the controller circuitry in detail. In this specific implementation, a Hitachi H8/3802 device (e.g., one time programmable device HCD6473802) 1110 drives a 4×10 LCD display 1112.

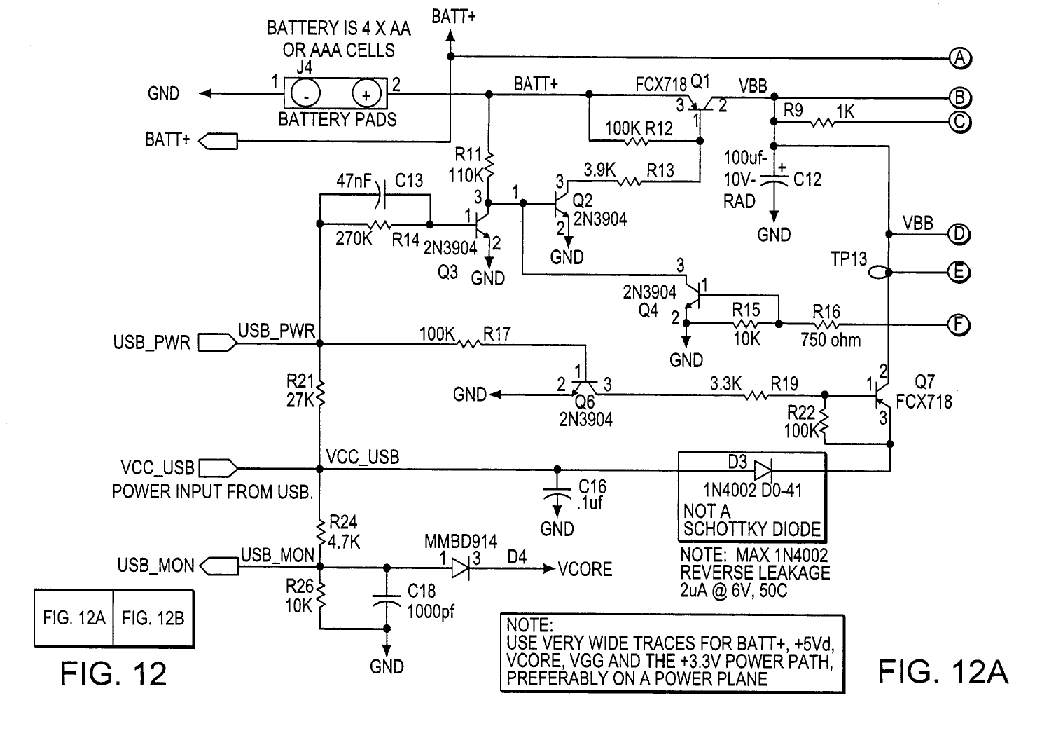

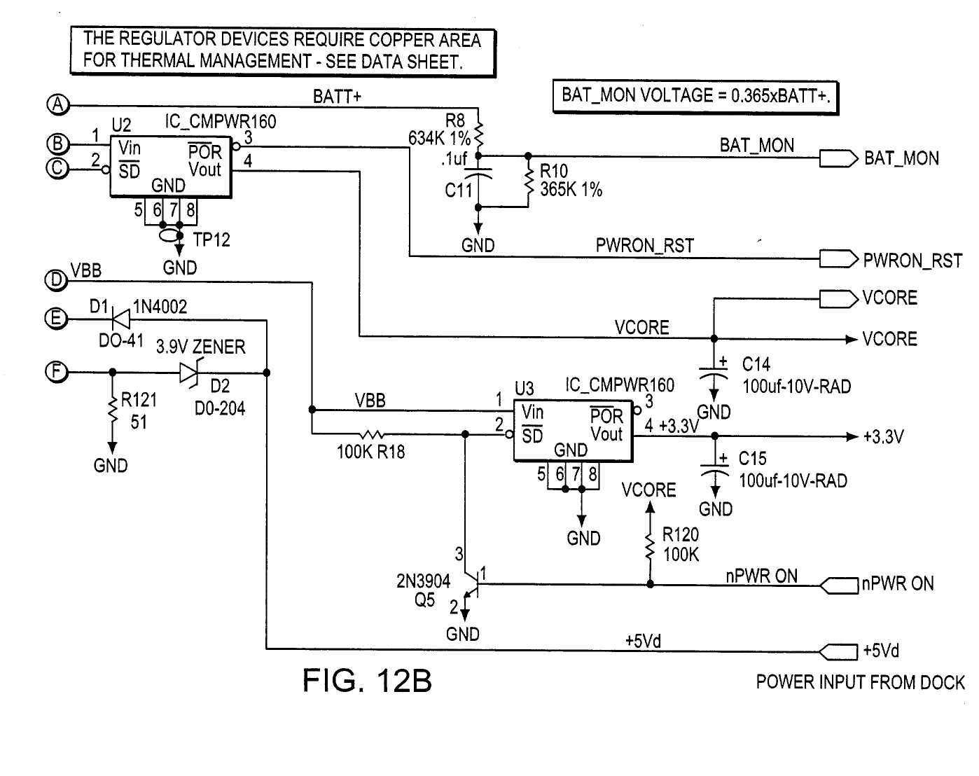

FIG. 12 illustrates the power circuitry in detail. In this specific implementation, California Micro Devices (215 Topaz St., Milpitas, Calif. 95035) CMPWR150 regulators are used to derive regulated power for the camera from four battery cells or power supplied by the docking station.

As shown in FIG. 4, the camera has a docking connector J1 that carries docking connector signals between the camera and the docking station. The docking connector may be a 16 pin shrouded post header. The docking connector signals include four user input button signals DSW1-DSW4 and an input button reference signal DSW_COM that originate at the docking station. Other docking connector signals include serial data transmission and reception signals TXC and RXC and transmission clock CCLK with a clock guard signal CLK_Guard_Run, and +5 volt power and ground that originate at the docking station. Further docking connector signals include camera flag signal CFLG and docking station signal DFLG that indicate to the docking station and camera, respectively, whether the camera is docked to the docking station.

Additional docking connector signals include composite video signal VIDEO and video guard signal Vid_Guard_Run, which helps to protect signal VIDEO from interference.

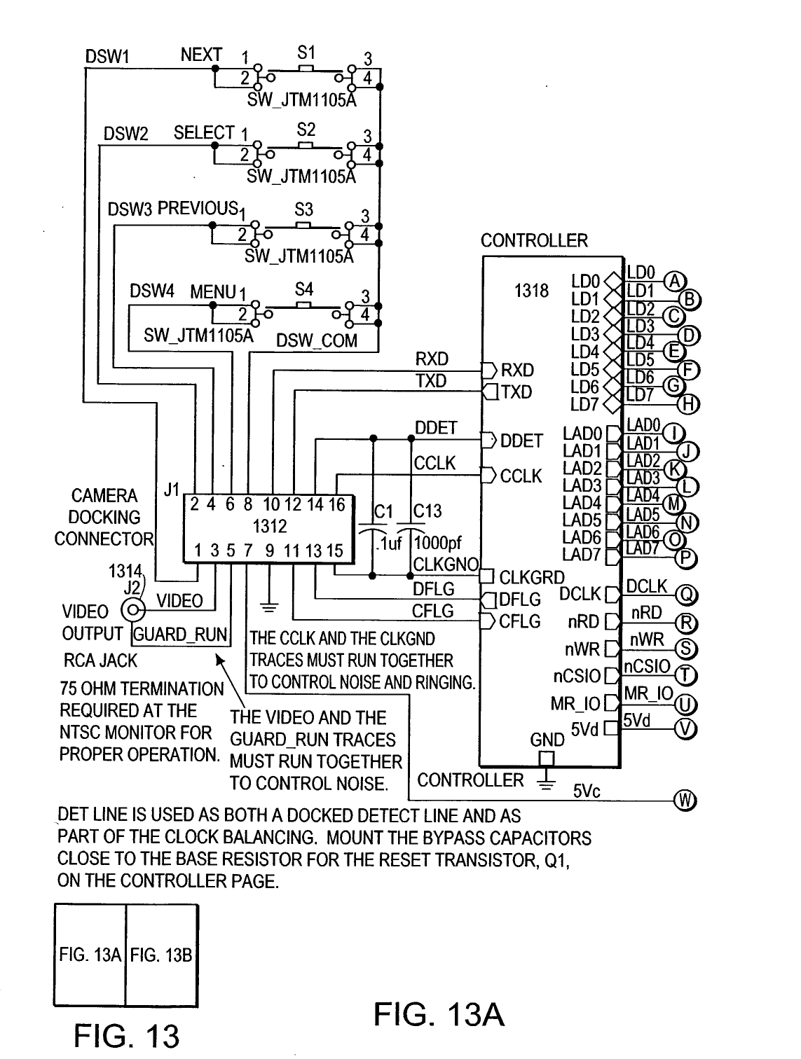

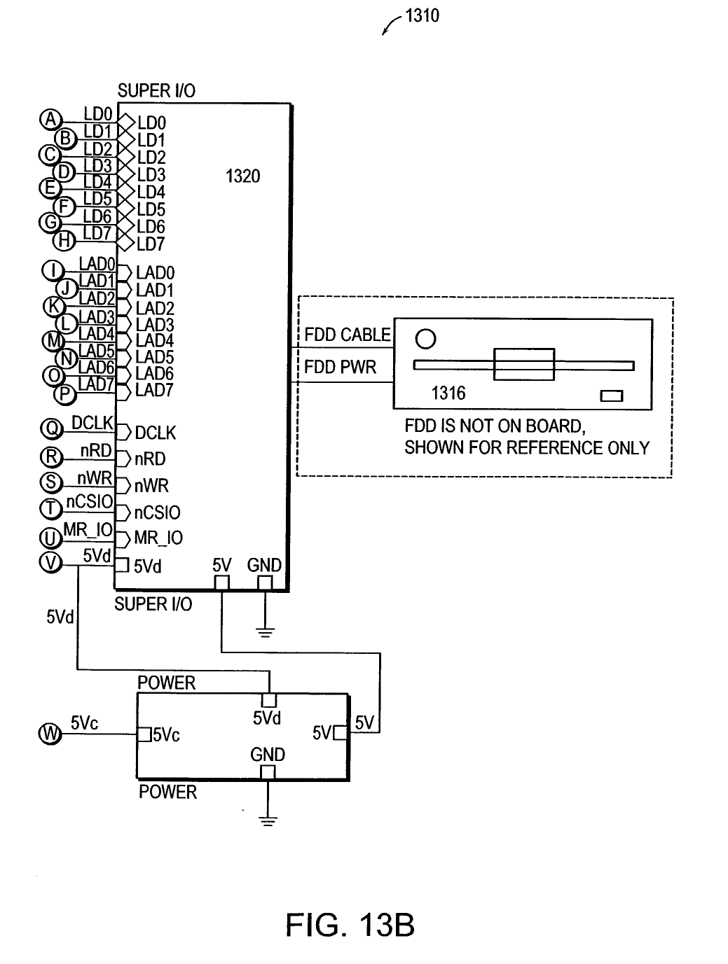

FIG. 13 illustrates a high level view of a circuit board 1310 of an example implementation of the docking station having a floppy diskette drive. Board 1310 has a camera docking connector 1312 that is configured to mate with the camera's connector J1 and that passes signals including button signals DSW1, DSW2, DSW3, DSW4, DSW_COM between board 1310 and the camera. Connector 1312 also receives VIDEO and Vid_Guard_Run (also referenced as “guard_run”) signals from the camera, which signals are carried to RCA connector 1314 which can be plugged directly into a conventional composite video input of a VCR or a television or an RF modulator device as described above. Thus, through the docking connectors, the camera can drive the television display without any assistance from a controller in the docking station.

Board 1310 also includes four SW_JTM1105A switches serving as buttons for interfacing with the DSW1, DSW2, DSW3, DSW4, DSW_COM signals.

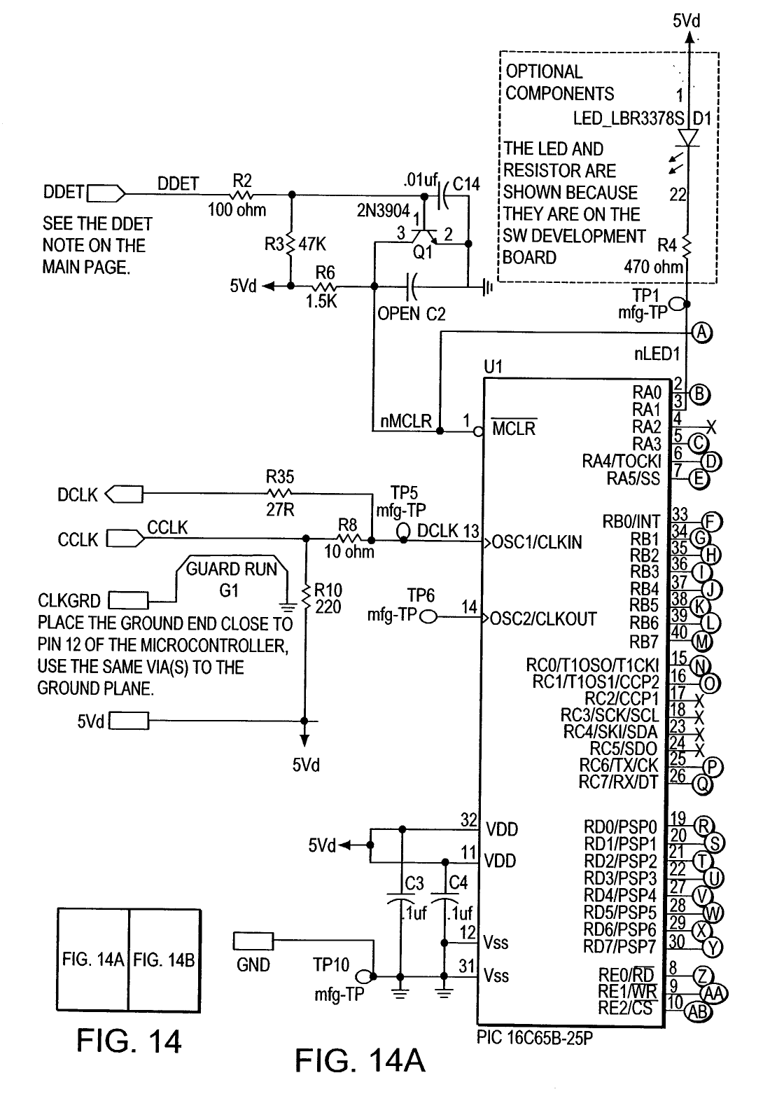

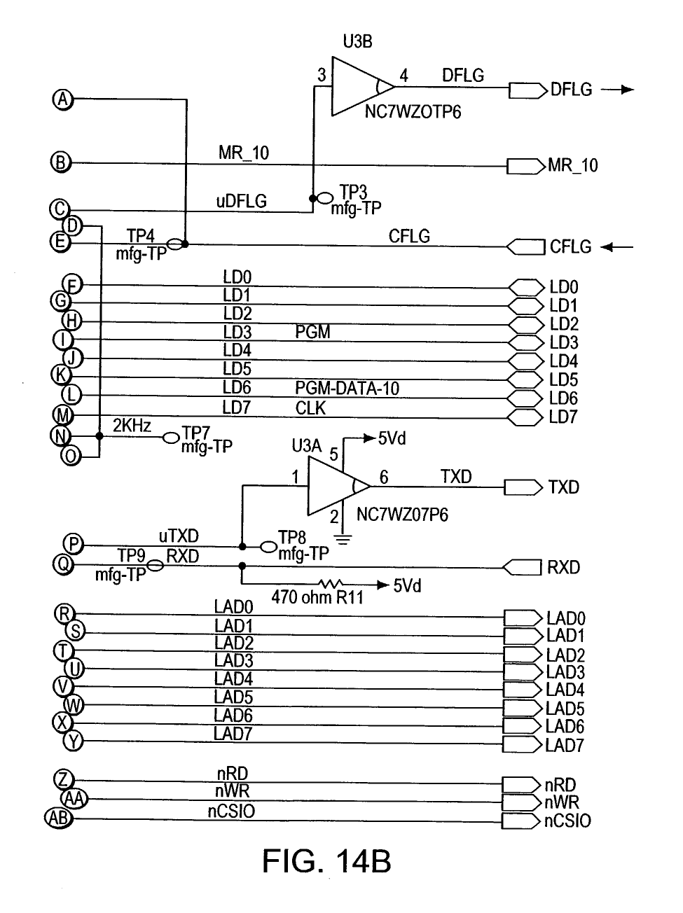

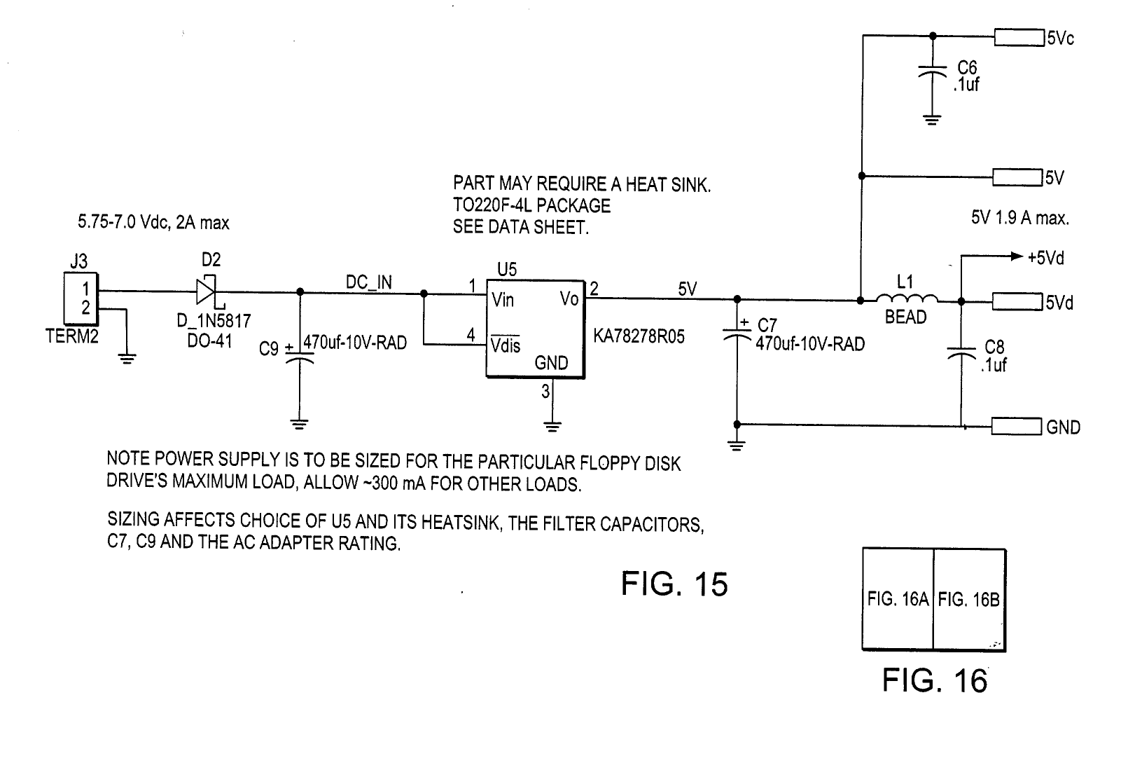

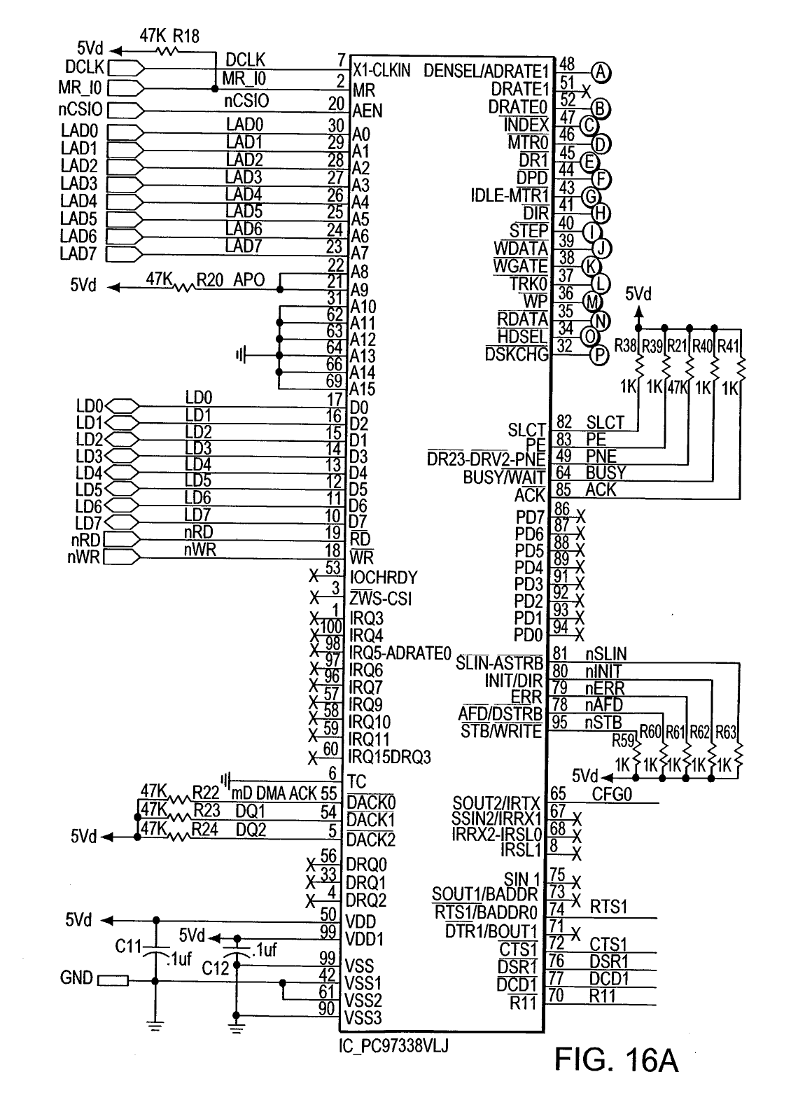

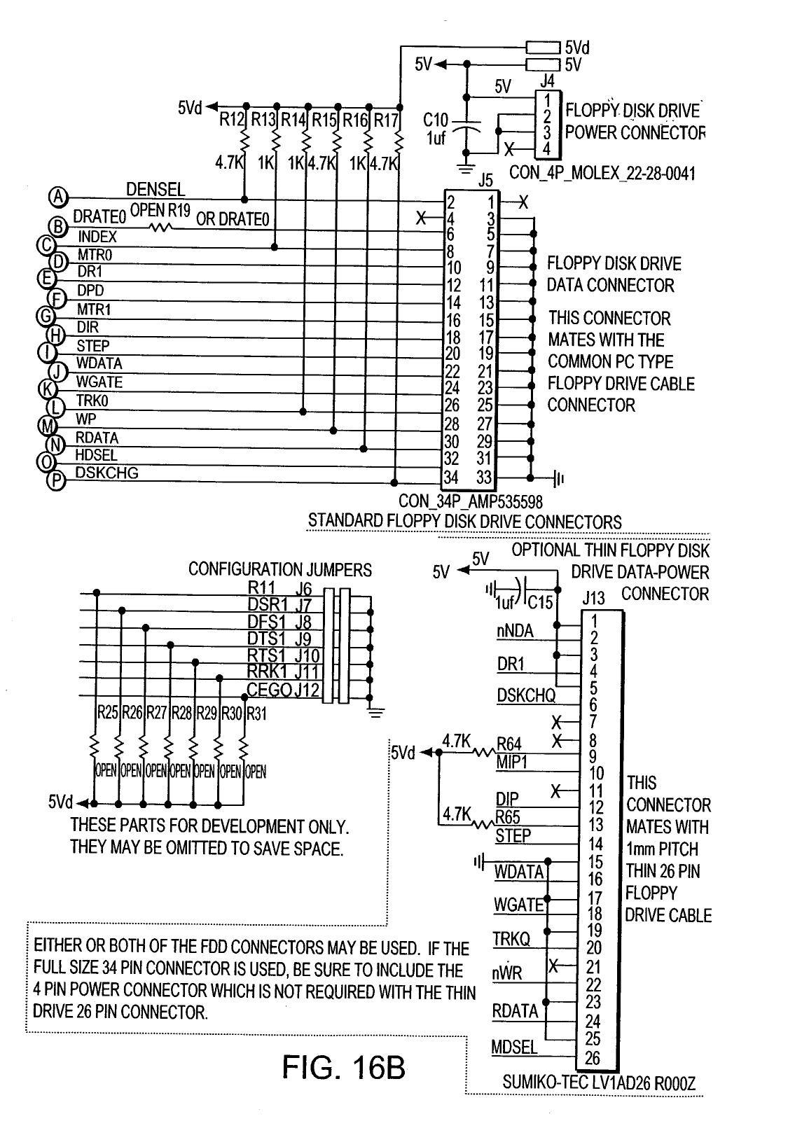

In this example implementation, the docking station has a floppy diskette drive referenced as 1316. Connector 1312 communicates with drive 1316 via controller 1318 (shown in more detail in FIG. 14) and high-speed input/output (“super I/O”) circuitry 1320 (shown in more detail in FIG. 16). Power circuitry 1322 (shown in more detail in FIG. 15) supplies electrical power to connector 1312, controller 1318, and super I/O circuitry 1320.

A television system selection setting determines which video output format, NTSC or PAL, is used for the television video output when the camera is connected to the docking station. NTSC format is the default and is used in the United States, Japan, and other countries. PAL format is used in Australia, Great Britain, and in many Western European countries. A Feature Select button is pressed until either an NTSC or a PAL symbol appears on the LCD display.

The system is configured for television display as follows. The docking station's video output RCA connector is connected to a video input (typically labeled “Video IN”) of the television or VCR. The television or VCR is tuned to the video input. NTSC or PAL is selected as the format for the video output. The camera is inserted into the docking station, and electrical connections are established. The camera is powered from the docking station. The first image stored in the camera's memory appears on the television screen, along with an image number in the upper right corner of the screen and a horizontal Menu Bar at the bottom of the screen. The image number also appears on the camera's LCD display. If there are no images in the camera's memory, the picture counter on TV screen displays “0”.

The Menu Bar displayed at the bottom of the screen has the following pictorial icons:

1. Source of Pictures (Camera or Disk)

2. Previous Picture (arrow facing left)

3. Next Picture (arrow facing right)

4. Copy This Picture

5. Copy All Pictures

6. Delete This Picture

7. Delete All Pictures

8. Rotate Image to the Left

9. Rotate Image to the Right

10. Slide Show

The docking station has buttons that operate as follows. A menu button causes the Menu Bar to be shown or hidden. If a “Show Menu Bar” option is chosen, inactive icons are displayed in black and white until selected as described below. Selected or active icons are highlighted, i.e., are displayed in different colors with a green border.

When the Menu Bar is shown, pressing the menu button causes the Menu Bar to be reduced to only one active icon displayed in the bottom left corner of the screen, with the “Disk Status” indicator in the bottom right corner. Pressing the menu button again causes the complete Menu Bar to be displayed.

A source of images icon indicates the source of the images shown on the television screen. In a default setting, images from the camera's memory are shown on the television, which is indicated by a depiction of a camera.

Other embodiments are within the scope of the following claims. For example, the camera may have one or more of the following: a higher resolution sensor, an enhanced flash capability, a more sophisticated lens, rechargeable batteries (e.g., that are charged while the camera is seated in the docking station), a wired or wireless remote control (e.g., an infrared remote control), a printer, a printer interface, a modem, a modem interface, an audio recording capability to allow voice annotation of images, and a CD-rewritable (CD-RW) drive or other removable storage media device. The docking station may have a small size corresponding to the footprint of the camera, or may have a larger size such as that of a VCR. The camera may use other batteries, such as thin profile AAA batteries. The docking station may have a thin profile floppy disk drive, and may be battery operated. The camera may be used to display electronic images on a television in real time, i.e., much as a live television broadcast. The camera or docking station may include game software and functionality to allow the user to play one or more games using the camera or docking station, e.g., in conjunction with a game console or a game display presented by the camera on a television screen.

What is claimed is:

1. A system for use in presenting electronic images, comprising:
a battery powered camera comprising:
an electronic image sensor generating an electronic image;
a television signal generator deriving a television signal from the electronic image; and
a docking station connector receiving the television signal and exposing the television signal; and
a docking station comprising:
a platform for receiving the battery powered camera in a docked position;
a camera connector for receiving the television signal from the docking station connector of the battery powered camera; and
a television connector for supplying the television signal to television equipment.

2. The system of claim 1, wherein the television signal includes a composite video signal.

3. The system of claim 1, wherein the television equipment includes video recording equipment.

4. The system of claim 1, wherein the television equipment includes a VCR.

5. The system of claim 1, wherein the television equipment includes a television screen.

6. The system of claim 1, wherein the television connector includes an RCA connector.

7. The system of claim 1, wherein the docking station connector includes a shrouded post connector.

8. The system of claim 1, wherein:
the battery powered camera further comprises a video guard signal generator supplying a video guard signal to the docking station connector; and
the camera connector receives the video guard signal from the docking station connector when the battery powered camera is in a docked position.

9. The system of claim 1, wherein the television signal generator includes a Sound Vision Inc. Clarity device.

10. The system of claim 1, wherein the nature of the television signal is independent of any microprocessor of the docking station.

11. The system of claim 1, wherein:
the docking station further comprises a user input button supplying a user input signal to the camera connector; and
the docking station connector receives the user input signal from the camera connector.

12. The system of claim 1, wherein the battery powered camera includes a USB interface.

13. The system of claim 1, wherein the docking station includes a removable media device communicating with the battery powered camera.

14. The system of claim 1, wherein the battery powered camera includes semiconductor memory for storing multiple electronic images.

15. The system of claim 1, wherein the battery powered camera, when in docked position, receives electrical power from the docking station.
